(19) United States
(12) Patent Application Publication
(10) Pub. No.: US 2007/0065749 A1
(43) Pub. Date: Mar. 22, 2007

(54) Radiation-markable coatings for printing and imaging

(76) Inventors: Vladek Kasperchik, Corvallis, OR (US); Jayprakash C. Bhatt, Corvallis, OR (US); Makarand P. Gore, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/231,571

(22) Filed: Sep. 21, 2005

(51) Int. Cl. G03C 1/00

(52) U.S. Cl. 430/270.1

(57) ABSTRACT

An light activated image recording medium, comprises a substrate, optionally, a color layer; and a layer of light-scattering pigment that becomes at least translucent when heated to a predetermined temperature.

### BACKGROUND

Compositions that produce a color change upon exposure to energy in the form of light or heat are of great interest in generating images on a variety of substrates. For example, digital data are recorded on CDs, DVDs, and other optical media by using a laser to create pits in the surface of the medium. The data can then be read by a laser moving across the surface and detecting variations in the reflectivity of the surface. While this method is highly effective for creating machine-readable features on the optical medium, those features are not easily legible to the human eye.

Materials that change visibly upon stimulation with energy such as light or heat may be used to create human-readable images. For ease of discussion, without subscribing to a particular effect of radiation, such materials will be referred to herein as “thermochromic materials” (which change color by the action of heat) and that term as used herein is intended to encompass materials that change color as a result of heat generated by the absorption of light.

It is particularly desirable to provide a coating that can be stimulated to change using the same laser that is used to write digital data onto the optical media. With such a coating, a single system could be used to produce both machine-readable and human-readable data on a CD, DVD, or other optical device. Due to the high volumes of optical data writers manufactured, the components such as light sources used in these drives are reasonably priced and readily available. Hence, it is desirable to provide a durable coating or surface that upon which visible markings can be made using an electromagnetic radiation (light) source such as data-recording laser. A preferred coating would also be inexpensive and easy to apply.

Inks formulated this way may be applied using a variety of techniques such as spin coating, screen printing, gravure printing, offset printing, roller coating and coated as a thin coating (1-20 um), and optionally might be cured into polymer matrix by electromagnetic radiation (typically UV).

### BRIEF SUMMARY

A radiation sensitive recording medium comprises a substrate, an optional color layer, and an imaging layer disposed on the substrate or the color layer, if present.

### BRIEF DESCRIPTION OF THE DRAWINGS

For a detailed description of exemplary embodiments of the invention, reference will now be made to the accompanying drawings, in which:

FIG. 1 is a schematic diagram illustrating an imaging medium according to an embodiment of the present invention; and

FIG. 2 is a schematic diagram of the imaging medium of FIG. 1 after heat has been applied so as to leave a visible mark.

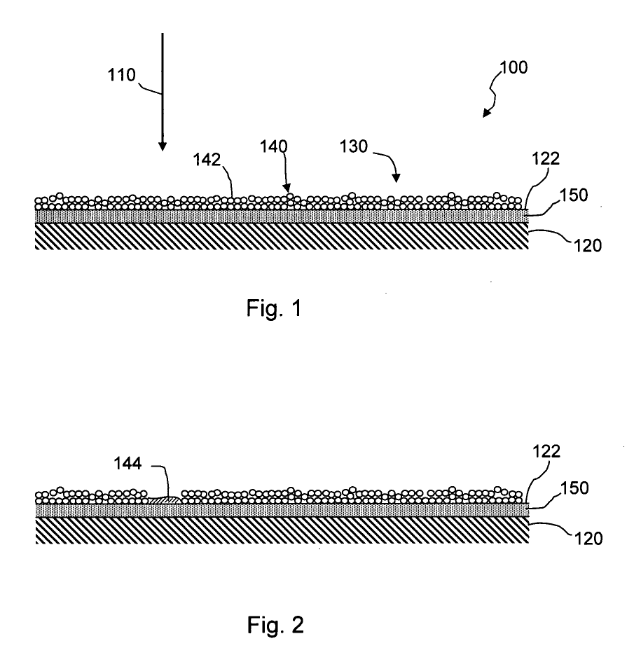

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

The term “antenna” means a radiation absorbing compound. The antenna readily absorbs a desired specific wavelength of the marking radiation, and transfers energy to cause or facilitate marking. The term “light” is used to include electromagnetic radiation of any wavelength or band, and from any source. As mentioned above, without subscribing to a particular effect of the radiation, the term “thermochromic” includes materials that change color when heated by the absorption of light and is used herein to describe a chemical, material, or device that exhibits a color change, as discerned by the human eye, when it undergoes a change in temperature.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Referring now to the Figures, there is shown an imagable medium 100 and incident energy beam 110. Imagable medium 100 may comprise a substrate 120 having an imaging composition 130 on a surface 122 thereof. Imaging composition 130 in turn may include a layer of light-scattering masking layer 140 on an optional color layer 150.

Substrate 120 may be any substrate upon which it is desirable to make a mark, such as, by way of example only, paper (e.g., labels, tickets, receipts, or stationary), metal, glass, ceramic, overhead transparencies, or the labeling surface of a medium such as a CD−R/RW/ROM or DVD±R/RW/ROM. Imaging composition 130 may be applied to the substrate via any acceptable method(s), such as, by way of example only, rolling, spin-coating, spraying, or screen printing.

Masking layer 140 may comprise a layer of light-scattering pigment particles 142 disposed on optional color layer 150. In certain embodiments, light-scattering pigment particles 142 comprise hollow polymeric microspheres, such as Ropaque® synthetic pigments, available from Rohm & Haas Company. The melting and fusion temperatures of these particles may be adjusted by changing the ratio of styrene and acrylic monomers and through selection of the acrylic monomer. The preferred pigments are spherical styrene/acrylic microspheres, which can be applied as water-based emulsions. The preferred pigments may have an average size of about 1 μm, but may alternatively have average sizes that are more or less than 1 μm.

During application of the imaging composition, the microspheres may be filled with water. In other embodiments, the microspheres may be filled with another liquid, depending on the desired composition of the coating layer before it is applied. As the coating dries, the liquid diffuses out of the microspheres and is replaced by air, resulting in discrete encapsulated air voids uniformly dispersed throughout the coating layer. These air voids scatter light as it passes through the microspheres. Because the particles 142 scatter incident light and prevent it from reaching the substrate or color layer (if present), marks can be made in masking layer 140 by removing or altering masking layer 140, as described below.

If desired, the emulsion in which light-scattering pigment particles 142 are dispersed prior to application may include a polymeric or other binder (not shown). The binder, if present, may cure or polymerize as the coating dries, improving adhesion of the particles 142 to each other and to the underlying surface. The binder, if present, is preferably but not necessarily substantially transparent in the amount and thickness that is used. The selection of such a binder is within the ordinary level of skill in the art.

If present, optional color layer 150 or undercoat can comprise any material that is colored or dark in appearance so that it will make a good visual contrast with the light-scattering fusible imagable layer, which typically has a light or close to white coloration. Any colored material that can be applied to the desired substrate as a coating layer and can form a supporting surface to which the marking layer can adhere is suitable. Color layer 150 may be any color, but is preferably a color that contrasts with the white or light-colored appearance of the light-scattering layer 140. Hence, coating layer may be a layer of black or dark-colored paint, such as CDG-9004—UV-curable black lacquer from “Nor-Cote International.” In some embodiments, it may be desired to provide a color layer 150 having non-uniform coloring across the surface of the substrate.

Imaging composition 130, the color layer 150, and/or the surface of the substrate 120 may include an absorber or antenna so as to increase absorbance of the available light energy. In some preferred embodiments, the absorber or antenna is tuned to the wavelength of the laser that will be used to create the desired marks. By effectively absorbing the available light, the absorber or antenna increases the heating effect of the laser, thereby enhancing the thermochromic response.

If present, the antenna may comprise any of a number of compositions that preferentially absorb light at a wavelength. The selected antenna may be dispersed or dissolved within the pigment particles, in the composition of the pigment particles 142 themselves, in the binder or carrier composition (liquid phase) if present, in the composition of substrate 120, or in color layer 150, if present. The content of the antenna in the imaging composition may be in the range of 0.05 to 50%, is preferably in the range of 0.1 to 10%, and more preferably in the range of 0.1 to 5%. In order to ensure that the imaging layer performs consistently and uniformly, it is preferred that the antenna be uniformly dissolved or dispersed in the imaging layer(s).

Without limitation, the antenna may be selected from the following compounds. For use with a 780 nm laser, preferred antenna dyes are:
(A) silicon 2,3 naphthalocyanine bis(trihexylsilyloxide) (Formula 1) (Aldrich 38,993-5, available from Aldrich, P.O. Box 2060, Milwaukee, Wis. 53201), and matrix soluble derivatives of 2,3 naphthalocyanine (Formula 2) 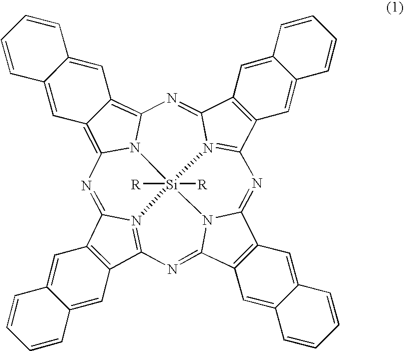
where R═—O—Si—(CH₂(CH₂)₄CH₃)₃; 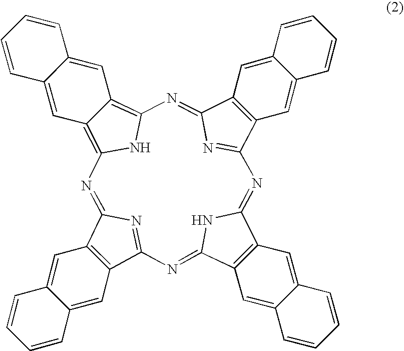
(B) matrix soluble derivatives of silicon phthalocyanine, described in Rodgers, A. J. et al., 107 J. PHYS. CHEM. A 3503-3514 (May 8, 2003), and matrix soluble derivatives of benzophthalocyanines, described in Aoudia, Mohamed, 119 J. AM. CHEM. SOC. 6029-6039 (Jul. 2, 1997), (substructures illustrated by Formula 3 and Formula 4, respectively): 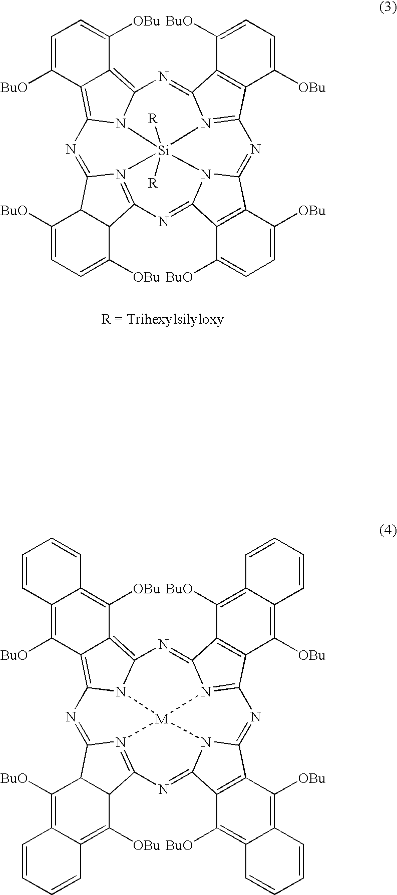
where M is a metal, and;
(C) compounds such as those shown in Formula 5 (as disclosed in U.S. Pat. No. 6,015,896) 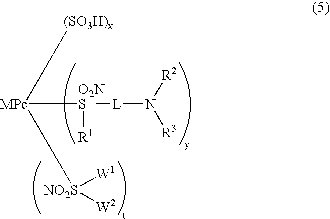
where M is a metal or hydrogen; Pc is a phthalocyanine nucleus; R¹, R², W¹, and W² are independently H or optionally substituted alkyl, aryl, or aralkyl; R³ is an aminoalkyl group; L is a divalent organic linking group; x, y, and t are each independently 0.5 to 2.5; and (x+y+t) is from 3 to 4;
(D) compounds such as those shown in Formula 6 (as disclosed in U.S. Pat. No. 6,025,486) 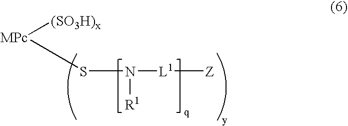
where M is a metal or hydrogen; Pc is a phthalocyanine nucleus; each R¹ independently is H or an optionally substituted alkyl, aryl, or aralkyl; L¹ independently is a divalent organic linking group; Z is an optionally substituted piperazinyl group; q is 1 or 2; x and y each independently have a value of 0.5 to 3.5; and (x+y) is from 2 to 5; or
(E) 800NP (a proprietary dye available from Avecia, PO Box 42, Hexagon House, Blackley, Manchester M9 8ZS, England), a commercially available copper phthalocyanine derivative.

Additional examples of the suitable radiation antenna can be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas can also be used in the present system and method and are known to those skilled in the art and can be found in such references as Infrared Absorbing Dyes, Matsuoka, Masaru, ed., Plenum Press, New York, 1990 (ISBN 0-306-43478-4) and Near-Infrared Dyes for High Technology Applications, Daehne, Resch-Genger, Wolfbeis, Kluwer Academic Publishers (ISBN 0-7923-5101-0), both of which are incorporated herein by reference.

Consideration can also be given to choosing the radiation antenna such that any light absorbed in the visible range does not adversely affect the graphic display or appearance of the color forming composition either before or after development. For example, in order to achieve a visible contrast between developed areas and non-imaged or non-developed areas of the coating, the color former can be chosen to form a color that is different than that of the background. For example, color formers having a developed color such as black, blue, red, magenta, and the like can provide a good contrast to a more yellow background. Optionally, an additional non-color former colorant can be added to the color forming compositions of the present system and method or the substrate on which the color forming composition is placed. Any known non-color former colorant can be used to achieve almost any desired background color for a given commercial product. Although the specific color formers and antennae discussed herein are typically separate compounds, such activity can also be provided by constituent groups of binders and/or color formers which are incorporated in the activation and/or radiation absorbing action of color former. These types of color former/radiation absorbers are also considered to be within the scope of the present system and method.

Various radiation antennas can act as an antenna to absorb electromagnetic radiation of specific wavelengths and ranges. Generally, a radiation antenna which has a maximum light absorption at or in the vicinity of the desired development wavelength can be suitable for use in the present system and method. For example, in one aspect of the present system and method, the color forming composition can be optimized within a range for development using infrared radiation having a wavelength from about 720 nm to about 900 nm in one embodiment.

Common CD-burning lasers have a wavelength of about 780 nm and can be adapted for forming images by selectively developing portions of the color forming composition. Radiation antennae which can be suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

Several specific polymethyl indolium compounds which can be used are available from Aldrich Chemical Company, and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof. Alternatively, the radiation antenna can be an inorganic compound, e.g., ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used in the present system and method. Suitable pyrimidinetrione-cyclopentylidene infrared antennae include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9CI) (S0322 available from Few Chemicals, Germany).

Further, the radiation antenna can be selected for optimization of the color forming composition in a wavelength range from about 600 nm to about 720 nm, such as about 650 nm. Non-limiting examples of suitable radiation antennae for use in this range of wavelengths can include indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium, 1-butyl-2-[5-(1-butyl-1,3-dihydro-3,3-dimethyl-2H-indol-2-ylidene)-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λmax=645 nm). Phthalocyanine dyes having a λmax of about the desired development wavelength can also be used such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, Jul. 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having a λmax=806 nm).

Laser light having blue and indigo wavelengths from about 300 nm to about 600 nm can be used to develop the color forming compositions. Therefore, color forming compositions may be selected for use in devices that emit wavelengths within this range. Recently developed commercial lasers found in certain DVD and laser disk recording equipment provide for energy at a wavelength of about 405 nm. Thus, the compositions discussed herein using appropriate radiation antennae can be suited for use with components that are already available on the market or are readily modified to accomplish imaging. Radiation antennae which can be useful for optimization in the blue (˜405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λ max=400 nm); ethyl 7-diethylaminocoumarin-3-carboxylate (λ max=418 nm); 3,3′-diethylthiacyanine ethylsulfate (λ max=424 nm); 3-allyl-5-(3-ethyl-4-methyl-2-thiazolinylidene) rhodanine (λ max=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d] 1,3-dithiole, all available from Syntec GmbH.

Non-limiting examples of specific porphyrin and porphyrin derivatives can include etioporphyrin 1 (CAS 448-71-5), deuteroporphyrin 1X 2,4 bis ethylene glycol (D630-9) available from Frontier Scientific, and octaethyl porphrin (CAS 2683-82-1), azo dyes such as Mordant Orange (CAS 2243-76-7), Merthyl Yellow (CAS 60-11-7), 4-phenylazoaniline (CAS 60-09-3), Alcian Yellow (CAS 61968-76-1), available from Aldrich chemical company, and mixtures thereof.

In each of these embodiments, generally, the radiation absorber can be present in the color forming composition as a whole at from about 0.1 wt % to about 5 wt %, and typically, from about 1 wt % to about 2 wt %, although other weight ranges may be desirable depending on the molar absorptivity of the particular radiation absorber.

When it is desired to create a visible mark on imagable medium 100, energy 110 may be directed imagewise onto the surface of imagable medium 100. The form of energy 110 may vary depending upon the equipment available, ambient conditions, and desired result. Examples of energy that may be used include but are not limited to IR radiation, UV radiation, x-rays, or visible light. The antenna absorbs the incident energy and causes localized heating of the imaging composition 130. The localized heat causes particles 142 to melt, fuse or nearly melt. It is preferred that particles 142 be raised to a sufficient temperature that they melt and collapse, releasing the gas that was contained within themselves and leaving a substantially flat and substantially gas-free mass of the polymer from which they were formed. In doing so, the particles turn from an opaque, light-scattering layer into a transparent layer. The resulting layer is illustrated as a polymer mass at 144 in FIG. 2.

The temperature required to cause melting and collapse of the particles 142 will vary, depending on the material of which the particles are made. In some embodiments, the temperature required is between about 50° C. and 200-350° C. and may be approximately 100° C. Because the target area is relatively small, the coating is relatively thin, and the coating is in contact with the significantly thicker substrate, the melted particles 142 cool relatively quickly and do not interfere with subsequent processing of the medium.

Because the amount of polymer remaining after the particles collapse is relatively small, it is at least translucent and may be transparent. In addition, the composition and structure of the microspheres may be selected such that the resulting polymer mass 142 is substantially transparent.

It is expected that the amount of heat required to mark the pigment will be significantly less than the amount of heat required to mark previously known coatings. In addition, the density of the present imagable coatings is less than that of other coatings, resulting in reduced thermal mass, easier heating and reduced weight and shipping costs.

The imaging compositions formed in the manner described herein can be applied to the surface of a medium such as paper, metal, glass, ceramic, CD, DVD, or the like. When the color-forming agent, optional antenna, and other components are selected appropriately, the same laser that is used to “write” the machine-readable data onto an optical recording medium, such as CD or DVD, can also be used to “write” human-readable images, including text and non-text images, onto the medium.

Thus, by way of example only, an imagable coating might comprise 98.7% of a Ropaque® HP-543 pigment dispersion (30% of solids by weight) and 1.3% Indocyanine Green. This coating was spin-coated onto one surface of a CD-R that had been coated with a black undercoat. The pigment layer was allowed to dry. The dried layer was about 3-4 μm thick and completely masked the black undercoat. This coating was then marked using an HP LightScribe-enabled CD/DVD-writer drive (HP DVD 540b) using writing laser power=34 mW, linear velocity=750 mm/sec and track density=2000 tpi. Human-readable marks were successfully created in this manner.

In certain embodiments, the machine-readable layers are applied to one surface of the optical recording medium and the present imaging compositions are applied to the opposite surface of the optical recording medium. In these embodiments, the user can remove the disc or medium from the write drive after the first writing process, turn it over, and re-insert it in the write drive for the second writing process, or the write drive can be provided with two write heads, which address opposite sides of the medium. Alternatively, separate portions of one side of the optical recording medium can be designated for each of the machine-readable and human-readable images.

Thus, embodiments of the present invention are applicable in systems comprising a processor, a laser coupled to the processor, and a data storage medium including a substrate having a first surface that can be marked with machine-readable marks by said laser and a second surface that can be marked with human-readable marks by said laser. The second surface includes an imaging composition in accordance with the invention, comprising an optional color layer, and a layer of light-scattering meltable pigment.

In yet other embodiments, one or more color forming layer(s) such as are described in the following applications, each of which is incorporated herein by reference, may be combined with the layers of this invention:

US Published Application No. 20050100817A1, entitled “Compositions, Systems, And Methods For Imaging,” filed Apr. 30, 2004;

US Published Application No. 20050089782A1, entitled “Imaging Media And Materials Used Therein,” filed: Oct. 28, 2003;

US Published Application No. 20050053860A1, entitled “Compositions, Systems, And Methods For Imaging,” filed Sep. 9, 2003;

US Published Application No. 20040147399A1, entitled “Black Leuco Dyes For Use In CD/DVD Labeling,” filed Feb. 10, 2003; and

US Published Application No. 20040146812A1, entitled “Compositions, Systems, And Methods For Imaging,” filed Jan. 24, 2003.

The present invention allows a higher writing speed, excellent image quality and image permanence, and ease of formulation and application.

The above discussion is meant to be illustrative of the principles and various embodiments of the present invention. Numerous variations and modifications will become apparent to those skilled in the art once the above disclosure is fully appreciated. For example, the composition and relative amount of the matrix, color-forming agent, nucleating agent, developer, if any, and photoabsorber, if any, can all be varied. It is intended that the following claims be interpreted to embrace all such variations and modifications. Similarly, unless explicitly so stated, the sequential recitation of steps in any claim is not intended to require that the steps be performed sequentially or that any step be completed before commencement of another step.

1. A light activated image recording medium, comprising:
a substrate,
optionally, a color layer; and
a layer comprising a light-scattering pigment that becomes at least translucent when heated to a predetermined temperature,
wherein at least one of said substrate, color layer, if present, and said layer comprising said light-scattering pigment includes an antenna having a peak absorbance wavelength or wavelength range matching a predetermined near infrared wavelength or wavelength range, such that said antenna causes localized heating of said medium when said antenna absorbs radiation in said predetermined near infrared wavelength or wavelength range.

2. The light activated image recording medium of claim 1 wherein said light-scattering pigment comprises hollow polymeric particles.

3. The light activated image recording medium of claim 1 wherein said light-scattering pigment comprises particles having an average size no greater than 1 μm.

4. The light activated image recording medium of claim 1 wherein said light-scattering pigment comprises styrene/acrylic microspheres.

5. The light activated image recording medium of claim 1 wherein said layer comprising said light-scattering pigment includes a binder.

6. The light activated image recording medium of claim 1 wherein one of said layer comprising said light-scattering pigment and said color layer includes said antenna.

7. The light activated image recording medium of claim 1 wherein one of said layer comprising said light-scattering pigment and said substrate includes said antenna.

8. A means for providing human-readable marks on a light activated image recording medium, comprising:
a means for recording human-readable marks on said medium, said means including a masking layer that produces a human-detectable optical change in response to a triggering near infrared signal above a threshold power level, wherein said masking layer includes an antenna having a peak absorbance wavelength or wavelength range corresponding to a predetermined near infrared wavelength or wavelength range, and light-scattering particles that cease to mask when exposed to said predetermined triggering near infrared signal.

9. The means according to claim 8, further comprising a means for recording machine readable marks on said medium in response to said predetermined triggering near infrared signal.

10. The means according to claim 9 wherein said light-scattering particles comprise hollow polymeric particles.

11. The means of claim 9 wherein said light-scattering particles have an average size no greater than 1 μm.

12. The means of claim 9 wherein said light-scattering particles comprise styrene/acrylic microspheres.

13. A system, comprising:
a processor,
a laser coupled to said processor, and capable of emitting a predetermined near infrared wavelength or wavelength range;
a data storage medium including a substrate having a surface that can be marked with human-readable marks by said laser, said surface including an imaging composition thereon, said imaging composition comprising:
a layer comprising light-scattering pigment that becomes at least translucent when heated to a predetermined temperature; and
optionally, a color layer between said substrate surface and said layer comprising said light-scattering pigment,
wherein at least one of said substrate, color layer, if present, and said layer comprising said light-scattering pigment includes an antenna having a peak absorbance wavelength or wavelength range corresponding to a predetermined near infrared wavelength or wavelength range, such that said antenna causes localized heating of said medium when said antenna absorbs radiation in said predetermined near infrared wavelength or wavelength range emitted by said laser.

14. The system of claim 13, wherein the data storage medium also includes a surface that can be marked by machine readable marks by said laser.

15. The system of claim 13 wherein said light-scattering pigment comprises hollow polymeric particles.

16. The system of claim 13 wherein said light-scattering pigment comprises particles having an average size no greater than 1 μm.

17. The system of claim 13 wherein said light-scattering pigment comprises styrene/acrylic microspheres.

18. The system of claim 13 wherein said layer comprising said light-scattering pigment includes a binder.

19. The system of claim 13 wherein one of said layer comprising said light-scattering pigment and said color layer includes a light-absorbing antenna.

20. The system of claim 13 wherein one of said layer comprising said light-scattering pigment and said substrate includes a light-absorbing antenna.

21. A method for creating a light activated image recording medium on a substrate, comprising:
a) combining a light-scattering pigment in a carrier fluid to form a coating mixture; by:
b) applying the coating mixture to part of the surface of a substrate;
c) allowing the carrier fluid to evaporate, leaving a layer of pigment on said part of said surface, to provide a light activated image recording medium on said substrate that is capable of forming human readable marks in response to incident light having a predetermined near infrared wavelength or wavelength range,
wherein at least one of said substrate and said layer comprising said pigment includes an antenna having a peak absorbance wavelength or wavelength range corresponding to said predetermined near infrared wavelength or wavelength range, such that said antenna causes localized heating of said medium when said antenna absorbs radiation in said predetermined near infrared wavelength or wavelength range.

22. (canceled)

23. The method of claim 21 wherein said light-scattering pigment comprises hollow polymeric particles.

24. The method of claim 21 wherein said light-scattering pigment comprises particles having an average size no greater than 1 μm.

25. The method of claim 21 wherein said light-scattering pigment comprises styrene/acrylic microspheres.

26. The method of claim 21 wherein said coating mixture comprising said light-scattering pigment includes a binder.

27.-28. (canceled)

29. The medium of claim 1, wherein said predetermined near infrared wavelength or wavelength range is in the range of about 720 nm to about 900 nm.

30. The medium of claim 1, wherein said predetermined near infrared wavelength or wavelength range is in the range of about 600 nm to about 720 nm.

31. The medium of claim 1 wherein said predetermined near infrared wavelength is 650 nm.
